(19) United States
(12) Patent Application Publication
(10) Pub. No.: US 2026/0027569 A1
(43) Pub. Date: Jan. 29, 2026

(54) SPRAY NOZZLE

(71) Applicant: medmix Switzerland AG, Haag (CH)

(72) Inventors: Nicole REY, Haag (CH); William LACEY, Haag (CH)

(21) Appl. No.: 18/784,664

(22) Filed: Jul. 25, 2024

(51) Int. Cl. B05B 1/04; B33Y 80/00

(52) U.S. Cl. CPC B05B 1/048; B33Y 80/00

(57) ABSTRACT

A spray nozzle is basically provided with an inlet space, a restriction and a nozzle orifice. The inlet space has an essentially cylindrical shape. The restriction has an essentially circular shape, with a contour of an inner surface of the spray nozzle tapering down in size with a first taper from the inlet space to the restriction and then tapering out in shape with a second taper from the restriction to the nozzle orifice, with the nozzle orifice having a stadium shape.

### BACKGROUND

### Technical Field

This disclosure generally relates to a spray nozzle. More specifically, the present disclosure relates to a spray nozzle that provides a homogeneous spray pattern.

### Background Information

Conventional spray nozzles can spray polyurethane foam adhesive for applications such as roofing. These spray nozzles spray foam adhesive that results in a line or bead of the material to secure the edges of waterproof membranes.

### SUMMARY

It has been determined that the bead of adhesive from some conventional nozzles results in a raised area in the membrane that collects dust, debris, and may even result in pooling water. Aesthetically this is an issue and the pooling water can lead to faster breakdown of the waterproof barrier. Thus, a dispersion of the spray foam adhesive with a spray nozzle to create a uniform surface is preferred to overcome this issue.

Furthermore, many conventional nozzles are complex, difficult to clean or expensive requiring many uses to be economical; however the adhesive for this application is fast curing and will commonly plug spray nozzles if set down mid application for any reason.

Another issue of concern is the conventional spray pattern. It has been determined that the desired pattern provides homogenous coverage of the adhesive with larger globule deposited onto the substrate. Similarly having a consistent spray coverage area during application is important to maximize the efficiency and consistency during application. Many applicators require external air assist and/or a device such as a pump cart to regulate the fluid pressure going to the nozzle to produce consistent patterns. This results in additional support infrastructure that reduces or hinders speed and mobility.

In view of the state of the known technology and in accordance with a first aspect of the present disclosure, a spray nozzle is provided that basically comprises an inlet space, a restriction and a nozzle orifice. The inlet space has an essentially cylindrical shape. In this connection it should be noted that an essentially cylindrical shape means a shape that is at least 90% cylindrical.

The restriction has an essentially circular shape, with a contour of an inner surface of the spray nozzle tapering down in size with a first taper from the inlet space to the restriction and then tapering out in shape with a second taper from the restriction to the nozzle orifice, with the nozzle orifice having a stadium shape. In this connection it should be noted that an at least essentially circular shape means a shape that is at least 90% circular.

With the spray nozzle according to the first aspect, it is possible to reduce manufacturing costs while creating a fan shaped application pattern with a reasonably homogenous spray pattern to allow for a fast and efficient application with overlapping bands. This spray nozzle further does not require an external air assist or regulator to produce a consistent pattern over the pressure range (e.g., 300-100 psi) of the adhesive canister as it is emptied

In accordance with a second aspect of the present disclosure, the spray nozzle according to the first aspect is configured so that a ratio of diameter of the restriction to the cylindrical shape of the inlet space is selected in the range of 1:2 to 1:2.5.

With the spray nozzle according to the second aspect, it is possible to provide a specific ratio of diameter of the restriction to the cylindrical shape of the inlet space that enables a fan shaped application pattern with a reasonably homogenous spray pattern to allow for a fast and efficient application with overlapping bands.

In accordance with a third aspect of the present disclosure, the spray nozzle according to the first aspect is configured so that a ratio of length of the first taper from the inlet space to the restriction to a length of the inlet space is selected in the range of 1.8:1 to 1.4:1.

With the spray nozzle according to the third aspect, it is possible to provide a specific ratio of length of the first taper from the inlet space to the restriction to a length of the inlet space that enables a fan shaped application pattern with a reasonably homogenous spray pattern to allow for a fast and efficient application with overlapping bands. In this connection reasonably homogenous spray pattern means a spray pattern that is at least 70%, more preferably at least 80% most preferably at least 90% homogenous.

In accordance with a fourth aspect of the present disclosure, the spray nozzle according to the first aspect is configured so that a ratio of length of the second taper from the restriction to the nozzle orifice to the first taper is selected in the range of 1:3.5 to 1:4.6, especially in the range of 1:3.6 to 1:4.5.

With the spray nozzle according to the fourth aspect, it is possible to provide a specific ratio of length of the second taper from the restriction to the nozzle orifice to the first taper that enables a fan shaped application pattern with a reasonably homogenous spray pattern to allow for a fast and efficient application with overlapping bands.

In accordance with a fifth aspect of the present disclosure, the spray nozzle according to the first aspect is configured so that a ratio of a small diameter of the nozzle orifice to a large diameter of the nozzle orifice being selected in the range of 1:8 to 1:9, especially in the range of 1:8.2 to 1:8.8.

With the spray nozzle according to the fifth aspect, it is possible to provide a specific ratio of a small diameter of the nozzle orifice to a large diameter of the nozzle orifice.

In accordance with a sixth aspect of the present disclosure, the spray nozzle according to the first aspect is configured so that the spray nozzle is a two-piece spray nozzle made of only two pieces.

With the spray nozzle according to the sixth aspect, it is possible to reduce manufacturing costs while creating a fan shaped application pattern with a reasonably homogenous spray pattern to allow for a fast and efficient application with overlapping bands.

In accordance with a seventh aspect of the present disclosure, the spray nozzle according to the sixth aspect is configured so that the two pieces comprise a lower half shell and an upper half shell.

With the spray nozzle according to the seventh aspect, it is possible to provide a cost effective spray nozzle.

In accordance with an eighth aspect of the present disclosure, the spray nozzle according to the sixth aspect is configured so that the two pieces are symmetric with respect to one another.

With the spray nozzle according to the eighth aspect, it is possible to provide a cost effective spray nozzle.

In accordance with a ninth aspect of the present disclosure, the spray nozzle according to the sixth aspect is configured so that the two pieces are asymmetric with respect to one another.

With the spray nozzle according to the ninth aspect, it is possible to provide a cost effective spray nozzle that is easy to assemble.

In accordance with a tenth aspect of the present disclosure, the spray nozzle according to the ninth aspect is configured so that the two pieces are connected to one another via a tongue and groove connection. This means that the respective parts of the connection are formed complementary to one another.

With the spray nozzle according to the tenth aspect, it is possible to provide a cost effective spray nozzle that is easy to assemble.

In accordance with an eleventh aspect of the present disclosure, the spray nozzle according to the first aspect is configured so that the spray nozzle is made by one of additive manufacturing and injection molding.

With the spray nozzle according to the eleventh aspect, it is possible to provide a cost effective spray nozzle.

In accordance with a twelfth aspect of the present disclosure, the spray nozzle according to the first aspect is configured so that an outer surface of the inlet space comprises a hose barb.

With the spray nozzle according to the twelfth aspect, it is possible to provide a spray nozzle that is easily assembled with a spray device.

In accordance with a thirteenth aspect of the present disclosure, the spray nozzle according to the first aspect is configured so that the first taper tapers continuously in shape from the inner space to the restriction.

With the spray nozzle according to the thirteenth aspect, it is possible to provide a configuration of the first taper that enables a fan shaped application pattern with a reasonably homogenous spray pattern to allow for a fast and efficient application with overlapping bands.

In accordance with a fourteenth aspect of the present disclosure, the spray nozzle according to the first aspect is configured so that the second taper tapers continuously from the restriction to the nozzle orifice.

With the spray nozzle according to the fourteenth aspect, it is possible to provide a configuration of the second taper that enables a fan shaped application pattern with a reasonably homogenous spray pattern to allow for a fast and efficient application with overlapping bands.

Also, other objects, features, aspects and advantages of the disclosed spray nozzle will become apparent to those skilled in the art from the following detailed description, which, taken in conjunction with the annexed drawings, discloses preferred embodiments of the spray nozzle.

### BRIEF DESCRIPTION OF THE DRAWINGS

Referring now to the attached drawings which form a part of this original disclosure, an illustrative embodiment is shown.

FIG. 1 illustrates a spray nozzle in accordance with one embodiment attached to a spray device.

FIG. 2 is a top perspective view of the spray nozzle of FIG. 1;

FIG. 3 is a top view of the spray nozzle of FIG. 1;

FIG. 4 is a front view of the spray nozzle of FIG. 1;

FIG. 5 is a rear view of the spray nozzle of FIG. 1;

FIG. 6 is a top perspective view of the spray nozzle of FIG. 1 with the top portion removed;

FIG. 7 is a top view in section of the spray nozzle of FIG. 1;

FIG. 8 is a side view in section of the spray nozzle of FIG. 1;

FIG. 9 is a cross sectional view taken along line 9-9 of FIG. 3; and

FIG. 10 is an exploded view of FIG. 9.

### DETAILED DESCRIPTION

Selected embodiments will now be explained with reference to the drawings. It will be apparent to those skilled in the art of spray nozzles from this disclosure that the following descriptions of the embodiments are provided for illustration only and not for the purpose of limiting the invention as defined by the appended claims and their equivalents.

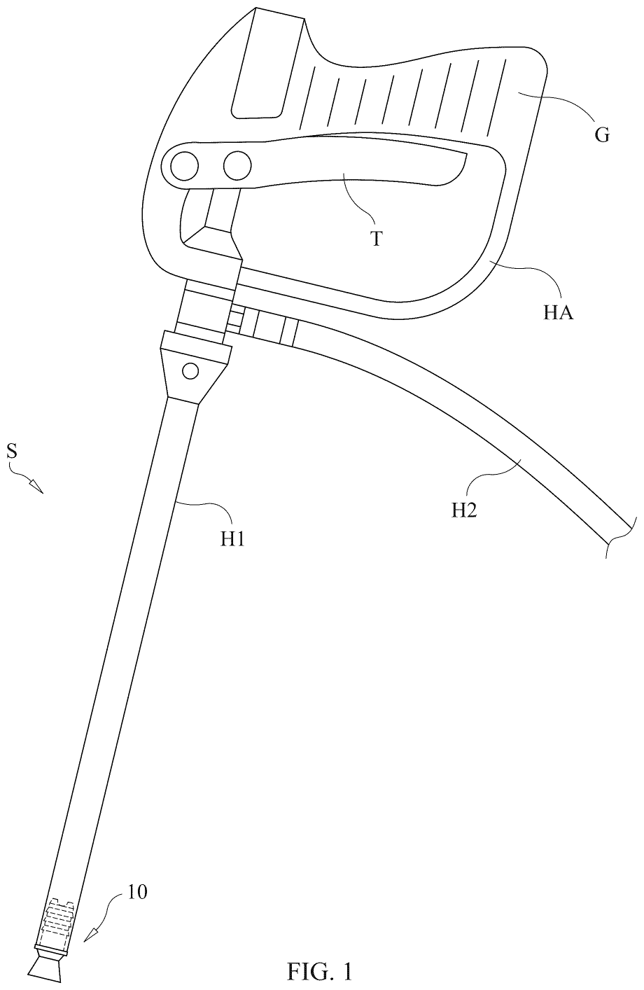

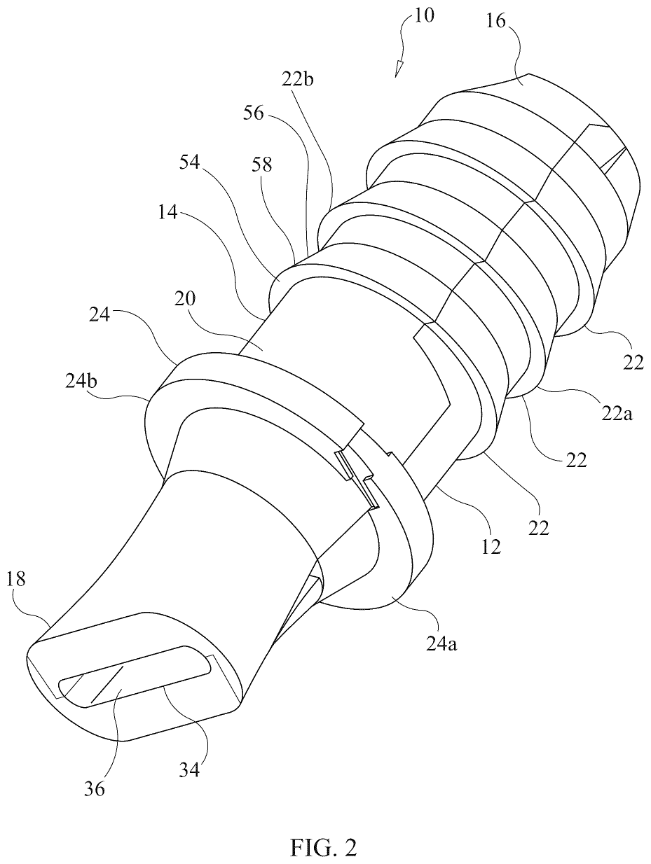

Referring initially to FIGS. 1 and 2, a spray nozzle 10 is illustrated in accordance with a first embodiment. As can be understood, the spray nozzle 10 can be attached to a spray device S. The spray nozzle 10 includes a first portion 12 and a second portion 14 that are coupled together. The first portion 12 and the second portion 14 can be injection molded to enable a reduced manufacturing cost.

Moreover, as discussed herein the spray nozzle 10 creates a fan shaped application pattern with a reasonably homogenous spray pattern to allow for fast and efficient application with overlapping bands. The spray nozzle 10 does not require an external air assist or regulator to produce a consistent pattern over the pressure range of the adhesive canister as it is emptied, generally operating in the range of 300-100 psi (approximately 2*10⁶ to 6.9*10⁵ Pa).

The spray device S can be any suitable spray device S capable of providing a spray. For example, the spray device S can be a device that is capable of spraying a polyurethane spray foam adhesive commonly used for roofing applications. The spray device S can be a device capable of operating in the range of 100-300 psi (approximately 6.9*10⁵ to 2*10⁶ Pa). without pressurized air. However, it is noted that the spray device S can use pressurized air, or other fluid (or gas) or be capable of spraying in any suitable manner.

In one embodiment, the spray device includes a handle HA with a trigger mechanism T and a grip G. A first hose or spray passage H1 is connected at one end to the handle HA and the spray nozzle 10 is connected at another end. A second hose H2 is connected to the handle HA at one end and to a cannister (not shown) or other device that holds the material to be sprayed. A user holds the handle HA at the grip G and can depress the or squeeze the trigger mechanism T. As can be understood, depressing or squeezing the trigger mechanism T causes material to be transferred from the canister (not shown) through the hose H2 and through the hose H1 exiting the spray device S through the spray nozzle 10. The material is then applied by the user to a surface in the desired manner.

Referring now to FIGS. 2-10, the spray nozzle 10 includes the first portion 12 (lower half shell) and the second portion 14 (upper half shell). The first portion 12 and the second portion 14 can be coupled together to form the spray nozzle 10. Thus, in one embodiment, the spray nozzle 10 is a two-piece spray nozzle 10 made of only two pieces. However, it is noted that the spray nozzle 10 can be formed from any number of portions, including one portion or more than two portions. The first and second portions 12 and 14 of the spray nozzle 10 can be injection molded plastic formed by injection molding. Alternatively, the spray nozzle 10 can be formed by 3D printing, additive manufacturing or in any suitable manner or combination and can be formed from any suitable material or combination of materials.

The spray nozzle 10 includes a first end 16, a second end 18 and an outer surface 20. The outer surface 20 has a plurality of hose barbs 22 for connection to the hose H2 or other outlet of the spray device S. As illustrated in FIG. 2, the hose barbs 22 can extend circumferentially around the outer surface 20 of the spray nozzle 10. The outer surface 20 further includes a circumferential ring 24. Since the spray nozzle, in this embodiment is formed from first and second portions 12 and 14, the hose barbs 22 and the circumferential ring are formed by two separate portions disposed on each of the first and second portions 12 and 14.

For example, in one embodiment, the first portion 12 includes a first plurality of hose barb portions 22a and a first circumferential ring portion 24a, and the second portion 14 includes a second plurality of hose barb portions 22b and a second circumferential ring portion 24b. When the first and second portions 12 and 14 are connected together, the first plurality of hose barb portion 22a and the second plurality of hose barb portions 22b form the plurality of hose barbs 22 for connection to the hose H2 or other outlet of the spray device S.

Similarly, when first and second portions 12 and 14 are connected together, the first circumferential ring portion 24a and the second circumferential ring portion 24b form the circumferential ring 24.

The circumferential ring portions 24a and 24b facilitate of the connection of the first and second portions 12 and 14 together. For example, as illustrated in FIGS. 6, 9 and 10, first and second portions 12 and 14 are identical and this description of one portion is a description of both portion 12 and 14. The first and second portions 12 and 14 include a recessed area 26 of the circumferential ring 24 and a protrusion 28 spaced from the outer surface 20 of the spray nozzle 10. During assembly of the first and second portions 12 and 14, the protrusion 28 is coupled to the recessed area 26, as discussed in more detail below.

The diameter of the outer surface 20 of the spray nozzle 10 when measured at the hose barbs 22 is about 10.5 mm. The largest width of the outlet is about 12.2 mm and the length of the spray nozzle 10 from the inlet 32 to the outlet 34 is about 30 mm.

Accordingly, when the first portion 12 and the second portion 14 are coupled together, the spray nozzle 10 includes an inner surface 30, the inlet 32 for an inlet space 36, a restriction 38 and a nozzle orifice (outlet 34). The inner surface 30 can be generally smooth without any protrusions or grooves therein. The inlet 32 is disposed at the first end 16 of the spray nozzle 10 and the nozzle orifice or the outlet 34 is disposed at the second end 18 of the spray nozzle 10.

The inlet space 36 extends from the inlet 32 in a direction towards the restriction 38 and has an essentially cylindrical shape having a first diameter D₁. The inner surface 30 then narrows to the restriction 38, forming a conical shape to the most narrow portion of the inner surface 30 (i.e., the restriction 38).

The restriction 38 has a generally circular configuration with a second diameter D₂. The second diameter D₂ is less than the first diameter D₁. In one embodiment, the ratio of diameter D₂ of the restriction 38 (the second diameter D₂) to the cylindrical shape of the inlet space 36 (the first diameter D₁) is selected in the range of 1:2 to 1:2.5.

The inlet surface 30 of the spray nozzle 10 tapers down in size with a first taper T₁ from the inlet space 36 to the restriction 38. The first taper T₁ tapers continuously in shape from the inlet space 36 to the restriction 38, and has a first length L₁ and forms an angle α with the longitudinal axis L_{A} of the spray nozzle 10. In one embodiment, the first length L₁ is between about 3 mm and 3.5 mm, and more preferably about 3.119 mm, and the angle α is between about 15 degrees and 18 degrees, and more preferably about 16.5 degrees.

The first length L₁ of the first taper T₁ is generally less than the length L_{I} of the cylinder defined by the inner surface 30. In one embodiment, the ratio of length L₁ of the first taper T₁ from the inlet space 36 to the restriction 38 to a length of the inlet space 36 (length L_{I}) is selected in the range of 1.8:1 to 1.4:1.

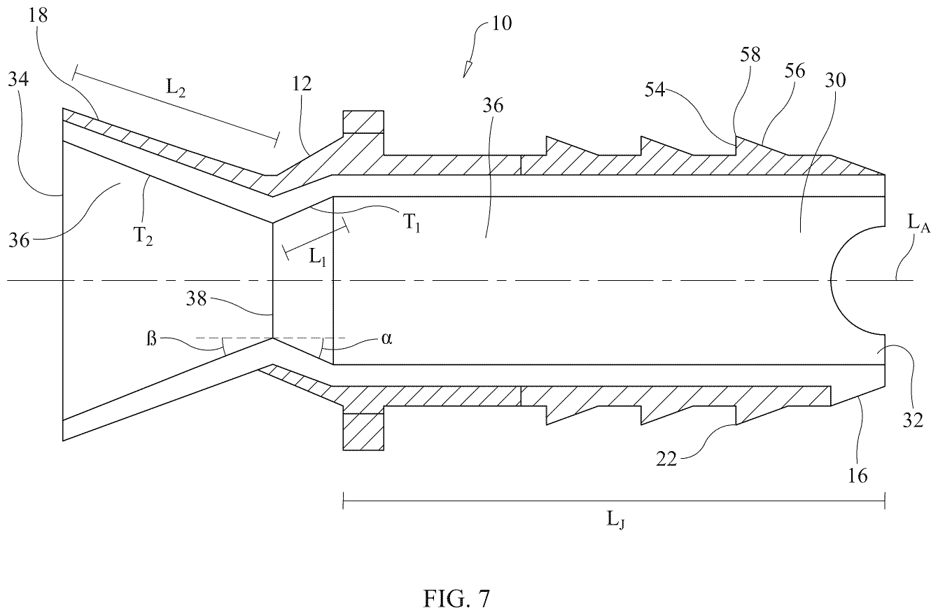

As illustrated in FIG. 7, when viewed along a first cross section, the inner surface 30 of the spray nozzle 10 then tapers out in shape with a second taper T₂ from the restriction 38 to the nozzle orifice 34. In this first cross section, the second taper T₂ tapers outwardly with a second length L₂ and forms an angle β with the longitudinal axis L_{A} of the spray nozzle 10. Angle β can be greater than angle α. In one embodiment, the second length L₂ is between about 7 mm and 8 mm, and more preferably about 7.449, and the angle β is between about 22 degrees and 23 degrees, and more preferably about 22.7 degrees.

As can be understood, the ratio of the second length L₂ to the first length L₁ is about 2:1 to about 2.67:1 and preferably about 2.39:1. The ratio of Angle β to angle α is about 1.2:1 to about 1.5:1, and preferably about 1.38:1.

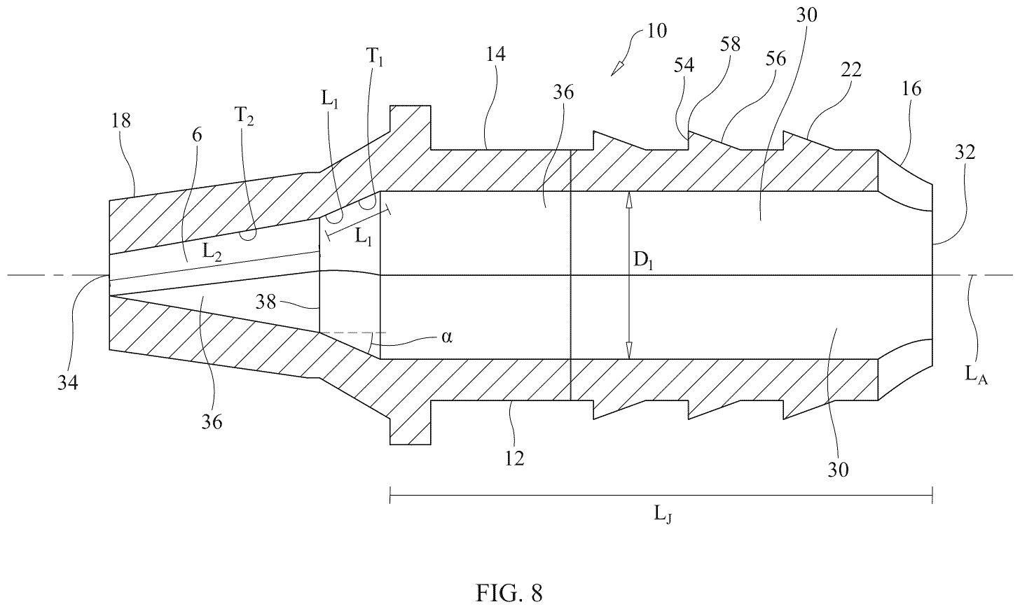

When viewed along a second cross section (90 degree off set from the first cross section above), as illustrated in FIG. 8, the inner surface 30 tapers (second tape T₂) inwardly from the restriction 38 to the outlet 34. In both cross sections, the second taper tapers T₂ continuously in shape from the inner surface 30 to the restriction 38 and can have the same or a similar length (i.e., the second length L₂).

In one embodiment, the ratio of length of the second taper from the restriction 38 to the nozzle orifice 34 to the first taper is selected in the range of 1:3.5 to 1:4.6.

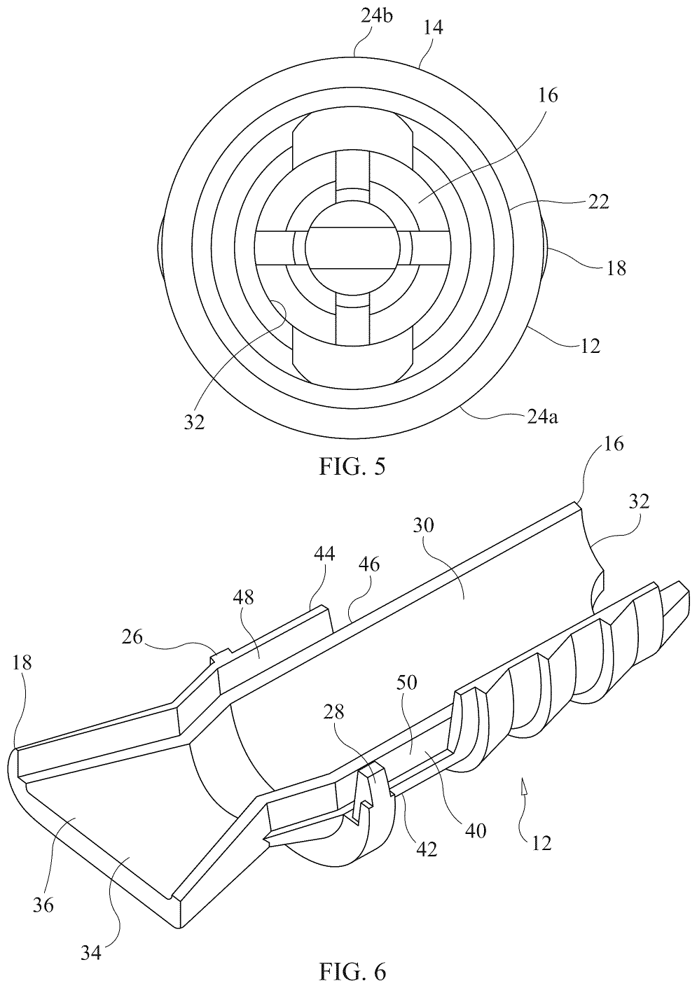

As illustrated in FIG. 4, the nozzle orifice 34 can have a stadium shape. As can be understood, the term stadium shape means a discorectangle, obround, or pill like shape, and can be a geometric figure including a rectangle with top and bottom lengths whose ends are capped off with semicircles of radius.

Thus, as can be understood, the nozzle orifice 34 has a small diameter D_{S} (or small width) and a large diameter D_{L} (or large width). The ratio of a small diameter D_{S} of the nozzle orifice 34 to a large diameter D_{L} of the nozzle orifice 34 being selected in the range of 1:8 to 1:9. It is noted that the nozzle orifice 34 can have any desired or suitable shape, such as elliptical.

A ratio of length of the first taper T₁ from the inlet space 36 to the restriction 38 to a length L_{I} of the inlet space 36 is selected in the range of 1.8:1 to 1.4:1.

A ratio of length L₂ of the second taper T₂ from the restriction 38 to the nozzle orifice 34 to the first taper T₁ is selected in the range of 1:3.5 to 1:4.6.

A ratio of a small diameter of the nozzle orifice 34 to a large diameter of the nozzle orifice 34 being selected in the range of 1:8 to 1:9.

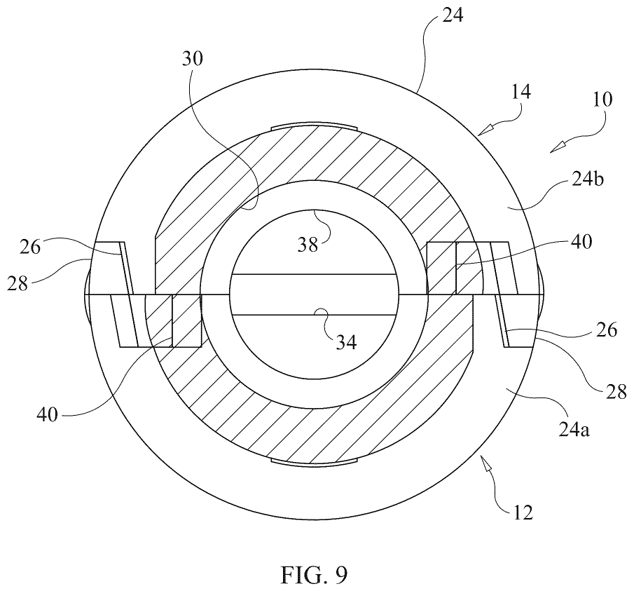

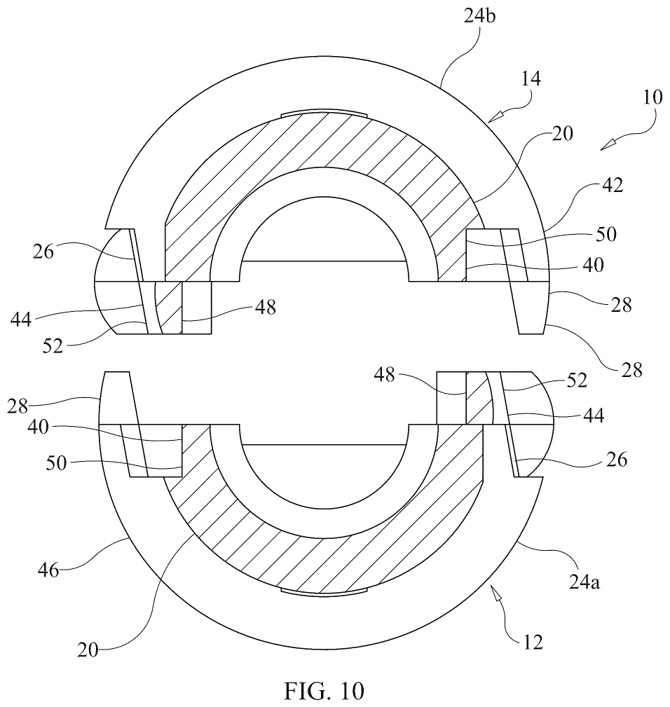

As shown in FIGS. 9 and 10, the first and second portions 12 and 14 can be generally symmetrical. That is, the first and second portions 12 and 14 can be identical in shape. Such formation of the first and second portions 12 and 14 enables the first and second portions 12 and 14 to be molded or formed in the same mold or the same device, providing cost efficient production.

It is noted that the first and second portions 12 and 14 can also be asymmetrical if desired. In other words, each of the first and second portions 12 and 14 can have a configuration in which one side of the portion is dissimilar from the other.

It is noted that the first and second portions 12 and 14 can be symmetrical and identical, asymmetrical and identical, symmetrical and different from each other and/or asymmetrical and different from each other.

As illustrated in FIGS. 6, 9 and 10, the outer surface 20 of the first and second portions 12 and 14 includes a recessed area 40 on a first side 42 and an overlapping area 44 on the second side 46.

In this embodiment, the overlapping area 44 couples to the recessed area 40. More specifically, the inner surface 48 of the overlapping area 44 contacts the outer surface 50 of the recessed area 40. This engagement will occur on both sides of the spray nozzle 10 forming a tight fit in a tongue and groove manner.

Moreover, as discussed above, the first and second portions 12 and 14 include the ring portion 24a and 24b that have the protrusion 28 on the first side 42. The protrusion 28 is spaced from the outer surface 50 of the recessed area 40 and is configured to engage or contact the outer surface 52 of the overlapping area 44.

The first and second portions 12 and 14 can be coupled together with a friction fit, using adhesive or in any suitable manner. As can be understood, the combination of the recessed area 40 and the overlapping area 44, along with the protrusion 28 with engaging the outer surface 52 provide a secure fit between the first and second portions 12 and 14.

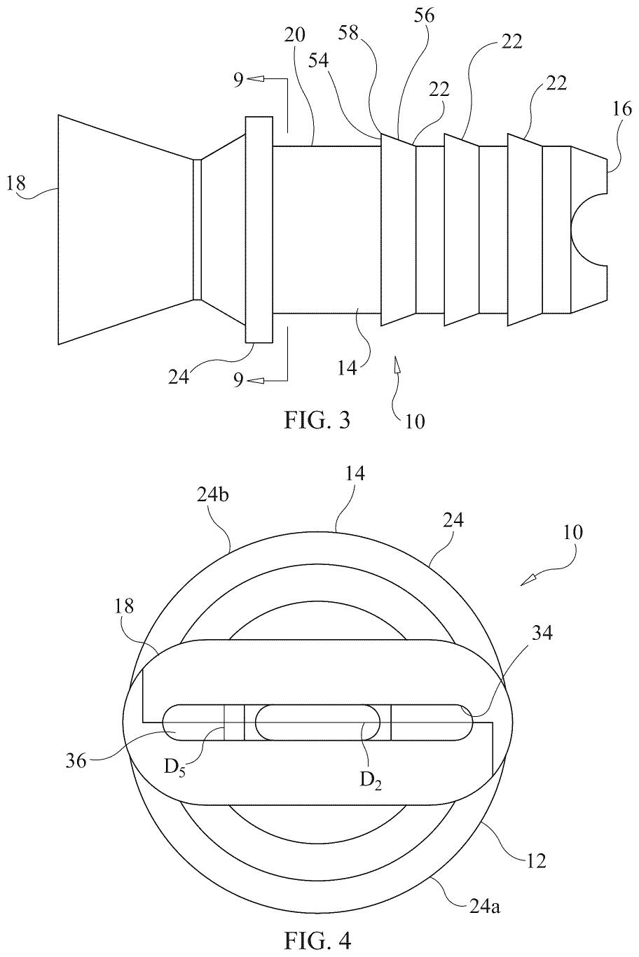

The outer surface 20 of the spray nozzle 10 includes the hose barbs 22. In the embodiment illustrated in FIGS. 2 and 3, the outer surface 20 includes three hose barbs 22. However, as can be understood, the outer surface 20 can include as many or as few hose barbs (including zero) desired. As illustrated, the hose barbs 22 have a first surface 54 that is generally perpendicular to the longitudinal axis LA of the spray nozzle 10 and a second surface 56 extending at an angle to the longitudinal axis of the spray nozzle 10. These surfaces form a triangular shape of the hose barb 22 with a point or edge 58 at the top thereof. Accordingly, the hose barb 22 is capable of securing the spray nozzle 10 to a hose H2 as illustrated in FIG. 1.

As discussed herein, the spray nozzle 10 can be made by one of additive manufacturing and injection molding. In one embodiment, the first and second portions 12 and 14 are symmetrical and are connected to one another via a tongue and groove connection. These portions are then connected to a hose H2.

The hose barbs 22 on the outer surface 20 of the spray nozzle 10 engage the inner surface of the hose H2 securing the spray nozzle 10 to the hose H2 of the spray device S. The spray nozzle 10 can then be used with the spray device S to provide a fan shaped application pattern with a reasonably homogenous spray pattern to allow for a fast and efficient application with overlapping bands.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a spray nozzle in an upright, riding position and equipped with the spray nozzle. Accordingly, these directional terms, as utilized to describe the spray nozzle should be interpreted relative to a spray nozzle in an upright riding position on a horizontal surface and that is equipped with the spray nozzle. The terms “left” and “right” are used to indicate the “right” when referencing from the right side as viewed from the rear of the spray nozzle, and the “left” when referencing from the left side as viewed from the rear of the spray nozzle.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Also, it will be understood that although the terms “first” and “second” may be used herein to describe various components, these components should not be limited by these terms. These terms are only used to distinguish one component from another. Thus, for example, a first component discussed above could be termed a second component and vice versa without departing from the teachings of the present invention.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.
1. Enumerated embodiments: A spray nozzle 10 comprising:
   an inlet space 36;
   a restriction 38; and
   a nozzle orifice 34, the inlet space 36 having an essentially cylindrical shape, the restriction 38 having an essentially circular shape, with a contour of an inner surface 48 of the spray nozzle 10 tapering down in size with a first taper T₁ from the inlet space 36 to the restriction 38 and then tapering out in shape with a second taper T₂ from the restriction 38 to the nozzle orifice 34, with the nozzle orifice 34 having a stadium shape.
2. A spray nozzle 10 according to embodiment 1, wherein a ratio of diameter of the restriction 38 to the cylindrical shape of the inlet space 36 is selected in the range of 1:2 to 1:2.5.
3. A spray nozzle 10 according to embodiment 1 or embodiment 2, wherein a ratio of length of the first taper T₁ from the inlet space to the restriction 38 to a length of the inlet space 36 is selected in the range of 1.8:1 to 1.4:1.
4. A spray nozzle 10 according to at least one of embodiments 1 to 3, wherein a ratio of length of the second taper T₂ from the restriction 38 to the nozzle orifice 10 to the first taper T₁ is selected in the range of 1:3.5 to 1:4.6.
5. A spray nozzle 10 according to at least one of embodiments 1 to 4, wherein a ratio of a small diameter of the nozzle orifice 10 to a large diameter of the nozzle orifice 10 being selected in the range of 1:8 to 1:9.
6. A spray nozzle 10 according to at least one of embodiments 1 to 5, wherein the spray nozzle 10 is a two-piece spray nozzle 10 made of only two pieces 12, 14.
7. A spray nozzle 10 according to embodiment 6, wherein the two pieces 12, 14 comprise a lower half shell 12 and an upper half shell 14.
8. A spray nozzle 10 according to embodiment 6 or embodiment 7, wherein the two pieces 12, 14 are symmetric with respect to one another.
9. A spray nozzle 10 according to one of embodiments 6 to 8, wherein the two pieces 12, 14 are asymmetric with respect to one another.
10. A spray nozzle 10 according to embodiment 9, wherein the two pieces 12, 14 are connected to one another via a tongue and groove connection.
11. A spray nozzle 10 according to one of embodiments 1 to 10, wherein the spray nozzle 10 is made by one of additive manufacturing and injection molding.
12. A spray nozzle 10 according to one of embodiments 1 to 11, wherein an outer surface 20 of the inlet space 36 comprises a hose barb 22.
13. A spray nozzle 10 according to one of embodiments 1 to 12, wherein the first taper tapers T₁ continuously in shape from the inner space to the restriction 38.
14. A spray nozzle 10 according to one of embodiments 1 to 13, wherein the second taper T₂ tapers continuously from the restriction 38 to the nozzle orifice 34.
15. A spray nozzle 10 according to one of embodiments 1 to 14, wherein a length L₁ of the first taper T₁ is about 3.119 mm.
16. A spray nozzle 10 according to one of embodiments 1 to 15, wherein a length L₂ of the second taper T₂ is about 7.449 mm.
17. A spray nozzle 10 according to one of embodiments 1 to 16, wherein a ratio of a length L₂ of the second taper T₂ to a length L₁ of the first taper T₁ is about 2.39:1
18. A spray nozzle 10 according to one of embodiments 1 to 17, wherein when viewed in a cross section the first taper T₁ tapers continuously in shape from the inlet space 36 to the restriction 38, and forms a first angle α of about 16.5 degrees.
19. A spray nozzle 10 according to one of embodiments 1 to 18, wherein when viewed in the cross section the second taper T₂ tapers continuously in shape from the inlet space 36 to the restriction 38, and forms a second angle β of about 22.7 degrees.
20. A spray nozzle 10 according to one of embodiments 1 to 19, wherein a ratio of the second angle β to the first angle α is about 1.38:1.

What is claimed is:

1. A spray nozzle comprising:
an inlet space;
a restriction; and
a nozzle orifice, the inlet space having an essentially cylindrical shape, the restriction having an essentially circular shape, with a contour of an inner surface of the spray nozzle tapering down in size with a first taper from the inlet space to the restriction and then tapering out in shape with a second taper from the restriction to the nozzle orifice, with the nozzle orifice having a stadium shape.

2. The spray nozzle according to claim 1, wherein a ratio of diameter of the restriction to the cylindrical shape of the inlet space is selected in the range of 1:2 to 1:2.5.

3. A spray nozzle according to claim 1, wherein a ratio of length of the first taper from the inlet space to the restriction to a length of the inlet space is selected in the range of 1.8:1 to 1.4:1.

4. A spray nozzle according to claim 1, wherein a ratio of length of the second taper from the restriction to the nozzle orifice to the first taper is selected in the range of 1:3.5 to 1:4.6.

5. A spray nozzle according to claim 1, wherein a ratio of a small diameter of the nozzle orifice to a large diameter of the nozzle orifice being selected in the range of 1:8 to 1:9.

6. A spray nozzle according to claim 1, wherein the spray nozzle is a two-piece spray nozzle made of only two pieces.

7. A spray nozzle according to claim 6, wherein the two pieces comprise a lower half shell and an upper half shell.

8. A spray nozzle according to claim 6, wherein the two pieces are symmetric with respect to one another.

9. A spray nozzle according to claim 6, wherein the two pieces are asymmetric with respect to one another.

10. A spray nozzle according to claim 9, wherein the two pieces are connected to one another via a tongue and groove connection.

11. A spray nozzle according to claim 1, wherein the spray nozzle is made by one of additive manufacturing and injection molding.

12. A spray nozzle according to claim 1, wherein an outer surface of the inlet space comprises a hose barb.

13. A spray nozzle according to claim 1, wherein the first taper tapers continuously in shape from the inner space to the restriction.

14. A spray nozzle according to claim 1, wherein the second taper tapers continuously from the restriction to the nozzle orifice.

15. A spray nozzle according to claim 1, wherein a length of the first taper is about 3.119 mm.

16. A spray nozzle according to claim 1, wherein a length of the second taper is about 7.449 mm.

17. A spray nozzle according to claim 1, wherein a ratio of a length of the second taper to a length of the first taper is about 2.39:1.

18. A spray nozzle according to claim 1, wherein when viewed in a cross section the first taper tapers continuously in shape from the inlet space to the restriction, and forms a first angle of about 16.5 degrees.

19. A spray nozzle according to claim 18, wherein when viewed in the cross section the second taper tapers continuously in shape from the inlet space to the restriction, and forms a second angle of about 22.7 degrees.

20. A spray nozzle according to claim 19, wherein a ratio of the second angle to the first angle is about 1.38:1.
